(19) United States
(12) Patent Application Publication
(10) Pub. No.: US 2012/0040643 A1
(43) Pub. Date: Feb. 16, 2012

(54) NETWORK ACCESS CONTROL BASED ON SERVING NODE IDENTIFIERS

(76) Inventors: John Diachina, Garner, NC (US); Paul Schliwa-Bertling, Ljungsbro (SE)

(21) Appl. No.: 13/051,801

(22) Filed: Mar. 18, 2011

Related U.S. Application Data
(60) Provisional application No. 61/373,505, filed on Aug. 13, 2010.

(51) Int. Cl. H04W 12/08

(52) U.S. Cl. 455/411

(57) ABSTRACT

Techniques for selectively barring access attempts based on network resource identifiers for serving core network nodes are described. In an example method, an access terminal determines whether access barring based on serving node identifiers is applicable to the access terminal. If so, the access terminal compares a broadcasted serving node identifier to an identifier for the serving core network node, and selectively suppresses access activity by the access terminal based on the comparison, e.g., if the serving core network node for the access terminal matches a broadcast node identifier.

### RELATED APPLICATION

This application claims the benefits under 35 U.S.C. §119(e) of U.S. Provisional Patent Application 61/373,505, filed 13 Aug. 2010. The entire contents of the foregoing application are incorporated herein by reference.

### BACKGROUND

The present invention relates generally to access control in mobile communication networks and more particularly to access control for machine-type communication devices.

The random access channel (RACH) in mobile communication networks provides contention-based access to communication devices to request connection setup when no traffic channel has been allocated to the communication device. In systems based on the GSM/EDGE standard, the communication device sends an access request message to the network on the RACH. The access request message includes a randomly generated reference value—such as the Reference Request information—for identification purposes, in lieu of an identifier such as the IMSI, for reasons of security and to minimize the amount of information sent by a communication device to accomplish contention resolution. The communication device then monitors the Access Grant Channel (AGCH) for a response. The network may either accept or deny the access request. If it accepts it, the network transmits an Immediate Assignment (IA) message on the AGCH, identifying the communication device by the random reference value included in the access request message and directing it to a traffic channel. If the network denies access to the requesting communication device, it transmits an Immediate Assignment Reject (IAR) message.

Contention occurs on the RACH occur when two or more communication devices attempt to access the communication network at the same time. In the event of a contention, the network will resolve the contention in favor of one of the communication devices. The unsuccessful communication devices will then “back-off” and make a new access attempt at a later time. As the number communication devices increases, there is a greater probability of contention between the communication devices and a greater number of access attempts will fail. If too many contentions occur, throughput on the RACH will be significantly reduced.

The anticipated introduction of a large volume of machine-type communication (MTC) devices in the near future will greatly increase the problem of congestion on the RACH. MTC devices are devices, such as a meter or sensor, that collect and send data to an MTC server or other MTC device over a communication network. It is expected that MTC devices will far outnumber non-MTC devices, such as user terminals for voice and data communications by human users. Therefore, there is a need to implement new procedures to control network access by MTC devices and minimize the impact on non-MTC devices.

### SUMMARY

Embodiments of the present invention provide methods and apparatus for controlling network access on a contention-based random access channel by machine-type devices or other access terminals. More particularly, techniques are described for selectively barring access attempts based on network resource identifiers for serving core network nodes.

Exemplary embodiments of the invention comprise methods of access control implemented by an access terminal. According to several embodiments, an access control method comprises determining whether access barring based on serving node identifiers is applicable to the access terminal, receiving a broadcasted serving node identifier, comparing the broadcasted serving node identifier to an identifier for a core network node serving the access terminal, and selectively suppressing access activity by the access terminal based on said determining and said comparing, e.g., if the serving core network node for the access terminal matches a broadcast node identifier. In some embodiments, such as a 3GPP GPRS/EDGE network, the broadcast serving node identifiers may comprise Network Resource Identifiers (NRIs).

In some embodiments, determining that access barring based on serving node identifiers is applicable to the access terminal comprises detecting a transmission of access control information broadcast from the mobile communication network, the access control information indicating that access barring based on serving node identifiers is in effect. In some of these and in some other embodiments, determining that access barring based on serving node identifiers is applicable to the access terminal comprises evaluating a first access barring rule based on a device type for the access terminal or based on an application type corresponding to an impending access attempt, or based on both. In some of these latter embodiments, the application type is one of a public safety application and a priority alarm application, and the first access barring rule indicates that access barring based on serving node identifiers is not applicable for public safety applications and priority alarm applications. The access barring rule may indicate that access barring based on serving node identifiers is applicable for low priority applications and generic service applications, in some of these and in other embodiments.

Access barring rules may be based on device service attributes or application service attributes. These may comprise several of a variety of types, including but not limited to: group membership; access point name; home PLMN; equivalent PLMN; visited PLMN; application data volume; device mobility; device visibility; frequency of transmission; frequency of server signaling; solicited operation; and extended access class membership.

Other embodiments include an access control method implemented by one or more fixed network nodes in a mobile communication network that includes a serving core network node serving one or more access terminals. In several of these embodiments, the access control method comprises determining that a processing load associated with at least a first category of access terminals exceeds a pre-determined threshold, and, responsive to said determining, broadcasting access control information to a plurality of access terminals. The broadcasted access control information indicates that access barring based on serving node identifiers is in effect. In some embodiments, the broadcasted access control information identifies one or more affected serving nodes.

Other embodiments include an MTC device implementing an access control scheme according to the techniques described herein. In one embodiment, the MTC device comprises a transceiver for communicating with a base station in a communication network and a control unit connected to the transceiver for controlling access to the a communication network by an application attempting to access the communication network. The control unit includes a processor configured to determine whether access barring based on serving node identifiers is applicable to the access terminal, receive a broadcasted serving node identifier, compare the broadcasted serving node identifier to an identifier for the core network node serving the access terminal, and selectively suppress access activity by the access terminal based on the comparison.

With the access control techniques described in further detail below, network operators are provided with the ability to bar system access by MTC applications with fine granularity. This control scheme also provides the network operator with the ability to determine what types of network accesses are barred at any point in time and the period for which the barring is to be applied. Of course, those skilled in the art will appreciate that the present invention is not limited to the above features, advantages, contexts or examples, and will recognize additional features and advantages upon reading the following detailed description and viewing the accompanying drawings.

### BRIEF DESCRIPTION OF THE DRAWINGS

FIG. 1 illustrates an exemplary communication network for communication by MTC devices.

FIG. 2 is a table illustrating access rules identifying applicability of access control information to each of several device types.

FIG. 3 is another table illustrating access rules identifying applicability of access control information to each of several device types.

FIG. 4 illustrates an exemplary access control procedure implemented by an access terminal.

FIG. 5 illustrates an exemplary access control procedure implemented by one or more fixed nodes in a wireless communication network.

FIG. 6 illustrates an example access terminal configured to implement an access control scheme.

### DETAILED DESCRIPTION

Those skilled in the art will appreciate that the use of the term “exemplary” is used herein to mean “illustrative,” or “serving as an example,” and is not intended to imply that a particular embodiment is preferred over another or that a particular feature is essential to the present invention. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

The term “access terminal” is used herein to refer generally to an end terminal that attaches to a wireless communication network, and may refer to either an MTC device or a non-MTC device. Thus, the term is generally intended to be synonymous with the term “User Equipment,” or UE, as that term is used by the 3^{rd}-Generation Partnership Project (3GPP), and includes standalone wireless devices, such as cellphones and wireless-equipped personal digital assistants, as well as wireless cards or modules that are designed for attachment to or insertion into another electronic device, such as a personal computer, electrical meter, etc.

Likewise, unless the context clearly indicates otherwise, the term “base station” is used herein in its most general sense to refer to a wireless access point in a wireless communication network, and may refer to base stations that are controlled by a physically distinct radio network controller as well as to more autonomous access points such as the so-called evolved Node B's (eNodeB) in Long-Term Evolution (LTE) networks.

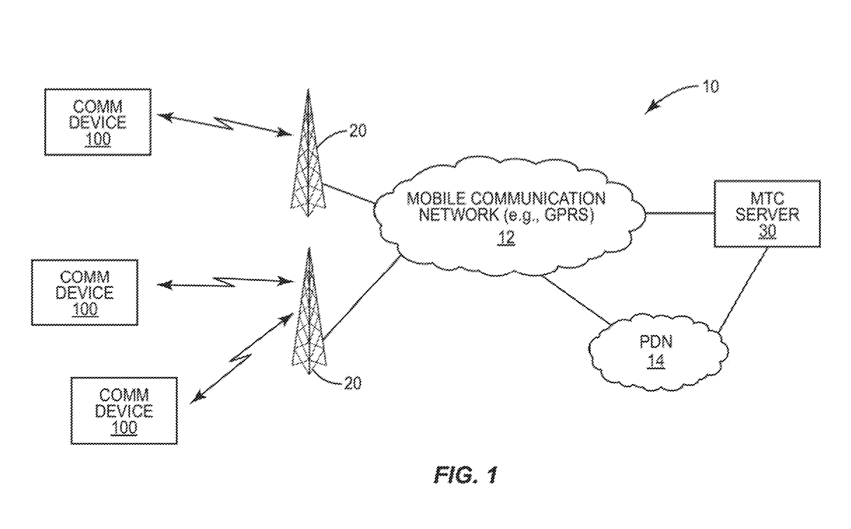

Referring now to the drawings, FIG. 1 illustrates an exemplary wireless communication network 10 including a core network 12, a plurality of base stations 20, and a plurality of communication devices 100. The communication network 10 may, for example, comprise a mobile communication network 12 that operates according to any standard that employs a contention-based random access channel (RACH). For illustrative purposes, an exemplary embodiment of the present invention will be described in the context of a network operating according to the GSM/EDGE (Global System for Mobile Communication (GSM) Packet Radio Service) standard. Those skilled in the art will appreciate, however, that the present invention is more generally applicable to other wireless communication systems, including Wideband Code Division Multiple Access (WCDMA), Long-Term Evolution (LTE), and Worldwide Interoperability for Microwave Access (WiMAX) systems. The mobile communication network 12 includes a plurality of base stations 20 that provide network access to mobile communication devices 100. The mobile communication network 12 connects to an external packet data network 14, such as the Internet. The communication devices 100 may communicate with one or more servers 30 connected to the mobile communication network 12 or packet data network 14.

The communication devices 100 may comprise machine-type communication (MTC) devices for collecting and reporting of data over a communication network or non-MTC devices. Machine Type Communications (MTC) has been defined as a specific type of wireless communication network traffic. See, e.g., 3GPP Technical Report 23.888, “System Improvements for Machine-Type Communications,” the disclosure of which is incorporated herein by reference in its entirety. One example of an MTC device is a gas or power meter with a wireless transceiver for reporting at predetermined time periods usage of gas or electrical power to the MTC server 30. Non-MTC devices are devices, such as a cell phone, smart phone, laptop computer, etc., used for voice and data communications by human users. An MTC device may comprise a dedicated device specifically for data collection and reporting. In other embodiments, a combined communication device 100 may function part of the time as a MTC device and part of the time as a non-MTC device.

In order to send the data, a communication device 100 must first establish a connection with the core network 12. Typically, the communication device 100 registers with the core network 12 on power up. After registering with the network 10, the communication device 100 may enter an IDLE mode. In the IDLE mode, the communication device 100 does not have an established connection with a base station 20. When the communication device 100 has data to send, it uses a random access procedure to establish a connection with the base station 20 to transmit the data. After the data is transmitted, the communication device 100 may terminate the connection with the base station 20 and return to an IDLE mode. In most typical applications, the communication device 100 will remain attached with the network 12. However, the communication device 100 could detach from the network 12 after sending the data.

Currently, both MTC devices and non-MTC devices all use the same RACH resources. Thus, MTC devices and non-MTC devices must contend with one another for access on the RACH. Due to the rapid growth of MTC devices, it is expected that the number of MTC devices will far exceed the number of non-MTC devices in the near future. To avoid overload and congestion of the RACH, the service providers will require a greater degree of control over network access by MTC devices.

MTC devices are likely to be configured (e.g., pre-programmed) with a profile identifying service-related attributes that correspond to each particular type of device and/or the applications supported by the device. Some of these attributes will be selected from a set of ubiquitous service-related attributes that identify broad types of devices and/or applications. For instance, these attributes might indicate that an application or device is delay tolerant, has low mobility, or has only small data transmission requirements. Given that MTC devices will have a specific profile of MTC service attributes, the radio access network (RAN) can apply an access control mechanism indicating that system accesses are barred for MTC devices having one or more of these service attributes enabled.

Applying this access control mechanism may be necessary during periods of heavy access load, so as to throttle the number of MTC devices that actually attempt system access during this time period. In other words, this access control mechanism effectively provides operators with the ability to bar system access attempts from MTC devices possessing different service attribute profiles. The ability to distinguish between devices having different service attributes permits the operator to regulate access attempts with an operator-determined granularity (i.e. from 0% to 100%), and for operator-determined time intervals.

In some cases, access control may be based on service-related attributes that identify an MTC device as belonging to a particular class of device, selected from a pre-determined set of device types or classes. One example of a set of device types from which a device type might be selected includes: Public Safety Device; Priority Alarm Device; Low-Priority Device; Generic Service Device. These device types might be defined as follows:

Public Safety Device (PSD)—these MTC devices support critical public services (police, ambulance, fire, national security etc.). Devices of this type are likely to be given preferred access to system resources.

Priority Alarm Device (PAD)—these MTC devices subscribe to the “Priority Alarm” MTC Feature and will only support time critical alarm related MTC applications. Again, devices of this type are likely to be given preferred access to system resources, although perhaps at a somewhat lower priority than PSDs.

Low Priority Device (LPD)—these MTC devices subscribe to the “Time Tolerant” MTC Feature and will only support low-priority MTC applications. These devices support applications that provide data that is not highly time sensitive and/or of low value.

Generic Service Device (GSD)—MTC devices that are not of type PSD, PAD or LPD will default to being of type GSD.

Of course, the preceding list of device types is only one example. Other possible sets of device types might contain more or fewer types.

As noted above, the access control mechanism consists of the transmission of access control information within system information transmitted by the RAN, for the purpose of filtering (i.e., barring) a controllable portion of system access attempts from MTC devices. To allow greater flexibility than might be provided by using barring based on MTC devices alone, access control of this type can be based on application-specific service attributes instead of or in addition to device-specific attributes. Indeed, a device-specific attribute such as any of those discussed above might be viewed as a special case of an application-specific service attribute, in which the device is restricted to a single application or to several applications having the same general characteristics.

Accordingly, an MTC device may be configured (e.g., pre-programmed) with either MTC device-specific service attributes or MTC application-specific service attributes, or both. This service attribution information may be programmed in the Universal Subscriber Identity Module (USIM), which is a logical entity that typically resides on a Universal Integrated Circuit Card (UICC). The MTC device can receive access control information transmitted by the wireless system, compare it to the stored service attribute information, and thus determine whether or not any given access attempt is barred.

Like the device-specific service attributes discussed above, the application-specific service attributes are selected from a pre-determined set. This pre-determined set may be based on the set of MTC Features that may be subscribed to by an MTC device (see 3GPP TS 22.368, “3^{rd} Generation Partnership Project; Technical Specification Group Services and System Aspects; Service Requirements for Machine-Type Communications (MTC); Stage 1 (Release 11),” v 11.0.1, February 2011). Following is one example of a set of MTC service attributes that may be configured within the (U)SIM of an MTC device (and sent as access control information). As will be seen, this list, which is only example of a set of MTC service attributes, comprises both device- and application-specific service attributes, which may overlap.

Public Safety Device (PSD)—this attribute is associated with MTC devices and/or applications supporting critical public services (police, ambulance, fire, national security etc.).

Priority Alarm Device (PAD)—MTC devices that subscribe to the “Priority Alarm” MTC Feature support priority alarm MTC applications.

Low Priority Device (LPD)—MTC devices that subscribe to the “Time Tolerant” MTC Feature support low priority MTC applications.

Group Member Device (GMD)—this attribute is associated with MTC devices that are part of at least one MTC group. MTC devices supporting this feature determine the specific MTC group for which they wish to attempt system access (for a given application) and shall read system information to determine whether system access is allowed for that MTC group.

APN Member Device (AMD)—this attribute is based on Access Point Name (APN)-related information that already exists in the device's SIM or USIM. MTC devices supporting this feature determine the specific APN for which they wish to attempt system access and shall read system information to determine whether system access is allowed for that APN.

Home PLMN Device (HPD)—this attribute is based on Public Land Mobile Network (PLMN)—related information that already exists in the device's SIM or USIM. MTC devices operating in a Home PLMN shall consider themselves to be a Home PLMN Device and shall read system information to determine whether they are allowed system access.

Equivalent PLMN Device (EPD)—this attribute is also based on PLMN related information that already exists in the device's SIM or USIM. MTC devices operating in an Equivalent PLMN shall consider themselves to be an Equivalent PLMN Device and shall read system information to determine whether they are allowed system access.

Visited PLMN Device (VPD)—this attribute is also based on PLMN related information that already exists in the device's SIM or USIM. MTC devices operating in a Visited PLMN shall consider themselves to be a Visited PLMN Device and shall read system information to determine whether they are allowed system access.

Small Data Volume (SDV)—MTC devices that subscribe to the “Small Data Transmissions” MTC Feature support MTC applications that send small amounts of data. Such an MTC device reads system information to determine whether system access is allowed.

Medium Data Volume (MDV)—Although not currently defined by 3GPP as an MTC Feature for subscription, this attribute can be useful for supporting an effective access control scheme. All MTC devices that have this attribute enabled in the SIM or USIM support MTC applications that send medium amounts of data. Such an MTC device reads system information to determine whether system access is allowed for medium data transmissions.

Large Data Volume (LDV)—Although not currently defined by 3GPP as an MTC Feature for subscription, this attribute can be useful for supporting an effective access control scheme. All MTC devices that have this attribute enabled in the SIM or USIM support MTC applications that send large amounts of data. Such an MTC device reads system information to determine whether system access is allowed for large data transmissions.

Low Mobility Operation (LMO)—MTC devices that subscribe to the “Low Mobility” MTC Feature support MTC applications for which infrequent mobility-related Non-Access Stratum (NAS) signaling is expected. Such an MTC device reads system information to determine whether system access is allowed for low mobility applications.

Low Visibility Operation (LVO)—Although not currently defined by 3GPP as an MTC Feature for subscription, this attribute can be useful for supporting an effective access control scheme. All MTC devices that have this attribute enabled in the SIM or USIM support MTC applications that require system attach (e.g., GPRS attach) immediately prior to sending MTC application data and then detach immediately thereafter. Such an MTC device reads system information to determine whether system access is allowed for low visibility applications.

Frequent Data Transmission (FDT)—Although not currently defined by 3GPP as an MTC Feature for subscription, this attribute can be useful for supporting an effective access control scheme. All MTC devices that have this attribute enabled in the SIM or USIM support MTC applications that require the frequent transmission of MTC application data. Such an MTC device reads system information to determine whether system access is allowed for frequent data transmission applications.

Frequent Server Signalling (FSS)—Although not currently defined by 3GPP as an MTC Feature for subscription, this attribute can be useful for supporting an effective access control scheme. All MTC devices that have this attribute enabled in the SIM or USIM support MTC applications that require the frequent transmission of signaling messages to the MTC server. Such an MTC device reads system information to determine whether system access is allowed for frequent MTC server signaling applications.

Solicited Access Operation (SAO)—Although not currently defined by 3GPP as an MTC Feature for subscription, this attribute can be useful for supporting an effective access control scheme. All MTC devices that have this attribute enabled in the SIM or USIM support MTC applications that require network solicitation (e.g., polling) to trigger the transmission of MTC application data. Such an MTC device reads system information to determine whether system access is allowed for solicited access operation applications.

Unsolicited Access Operation (UAO)—Although not currently defined by 3GPP as an MTC Feature for subscription, this attribute can be useful for supporting an effective access control scheme. All MTC devices that have this attribute enabled in the SIM or USIM support MTC applications that autonomously trigger the transmission of MTC application data. Such an MTC device reads system information to determine whether system access is allowed for unsolicited access operation applications.

Extended Access Class (EAC)—Although not currently defined by 3GPP as an MTC Feature for subscription, this attribute can be useful for supporting an effective access control scheme. All MTC devices can be assigned one of several possible EAC values. MTC devices will therefore read system information and determine whether access attempts are barred for their specific EAC.

Some MTC devices may be configured with both device-specific attributes and application-specific service attributes. In some embodiments, these devices may use both of these attribute types to determine whether access is barred for a particular application or application type. In particular, these devices may use the device-specific attribute to determine which, if any, of the application-specific access barring features are applicable. Thus, for instance, a device configured as a public safety device (i.e., having the PSD device-type attribute) can be configured according to a pre-determined rule establishing that transmitted access control information barring access to some types of applications should be heeded, while information barring access to other types of applications should be ignored.

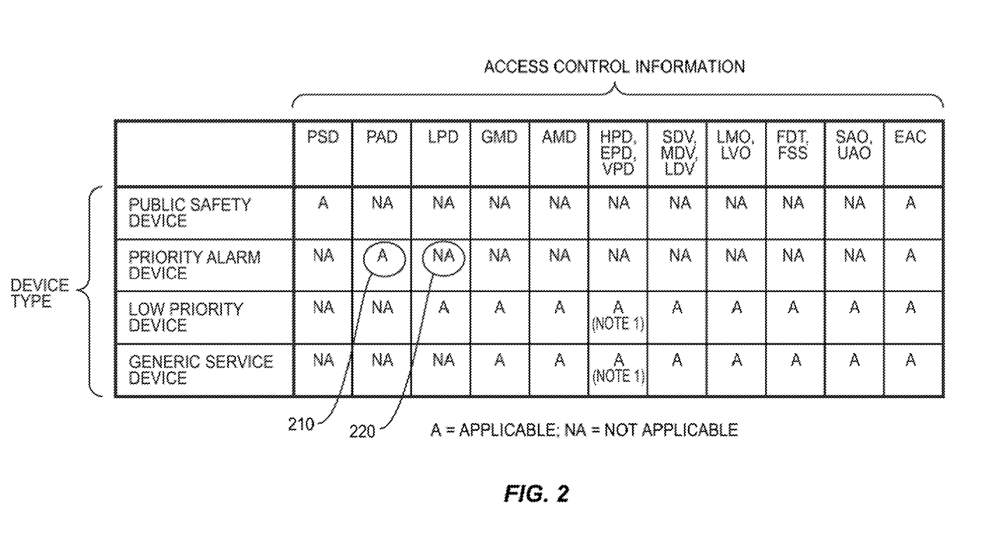

This approach is illustrated in FIG. 2, which is a table that cross-references the four device-specific attributes discussed above (i.e., PSD, PAD, LPD, and GSD) against access control information (ACI) corresponding to each of the several application-specific service attributes previously discussed. This table defines one possible set of rules defining how devices of each type should interpret access control information indicating which application types are barred.

Each of the rows in the table of FIG. 1 corresponds to a device type. Each of the columns corresponds to access control information indicating that access is barred for applications corresponding to one or more particular application-specific services. Given a particular device type, the corresponding row indicates which access control information is applicable. For instance, the entry labeled 210 indicates that access control information barring access to devices or applications having the PAD service attribute is applicable to MTC devices of the PAD device type. On the other hand, the entry labeled 220 indicates that access control information barring access to devices or applications having the LPD (low-priority device) service attribute is not applicable to MTC devices of the PAD device type. Likewise, for a Public Safety Device, FIG. 2 indicates that only access control information for the PSD attribute and the EAC attribute applies—access control information corresponding to the other service attributes may be ignored.

It should be noted that more than one application-specific service attribute may apply to a given device or application. In this case, access is barred if the access control information for any of the applicable service attributes indicates that access is barred. Thus, for instance, if a Low Priority Device (LPD attribute) following the table of FIG. 2 is running a Small Data Volume application (SOV attribute), then access is barred for that device if the access control information transmitted by the RAN indicates that access is barred for either one or both of the LPD attribute and the SDV attribute.

Further, more than one layer of access control may be applicable to a given MTC. In other words, even if the information relating to access control based on application-specific service attributes indicates that access is permitted, another layer of access control may nonetheless apply. For instance, extended access class (EAC) barring rules may be applied to all access attempts allowed by application-specific attribute barring, so that access is finally allowed to only a predetermined percentage of the MTC devices that pass through access control based on application-specific service attributes. Access class barring is described in a commonly owned U.S. patent application Ser. No. 13/051,345 titled “ACCESS CONTROL FOR MACHINE-TYPE COMMUNICATION DEVICES” (Ref. #P31715-US2) which is filed on the same date, Mar. 18, 2011, as this application with inventors John Diachina, Paul Schliwa-Bertling, Andreas Bergstrom, and Claes-Göran Persson, and which is incorporated herein by reference, in its entirety. Layered access control is described in commonly owned U.S. patent application Ser. No. 13/051,361 titled “LAYERED ACCESS CONTROL FOR MACHINE TYPE DEVICES” (Ref. #P32101-US3) which is also filed on the same date, Mar. 18, 2011, as this application with inventors John Diachina, Paul Schliwa-Bertling, and Andreas Bergström, and which is also incorporated by reference herein, in its entirety.

In Public Land Mobile Networks (PLMNs), a pool area is the geographical area within which a mobile station may roam without a need to change the serving core network node. A pool area may be served by a single core network node, or by two or more core network nodes in parallel. A RAN node service area consists of the coverage area provided by one or more cells, and belongs to one or more pool areas. In GSM and UMTS networks, the pool areas of the circuit-switched and packet-switched domains are configured independently, based on the granularity of RAN node service areas. If a location area or a routing area (spans multiple RAN node service areas, then all these RAN node service areas will belong to the same pool area.

The Network Resource Identifier (NRI) uniquely identifies an individual core network node, such as a Mobile Switching Center Server (MSC-Server) or Serving GPRS Support Node (SGSN), out of all core network nodes that serve a given pool area. The NRI information element has the same length in all of these core network nodes. Further, more than one NRI may be assigned to a core network node.

The NRI may be part of the temporary mobile station identity (TMSI) assigned to mobile stations that operate in the circuit-switched domain, or part of the packet temporary mobile station identity (P-TMSI) assigned to mobile stations that operate in the PS domain. The NRI has a configurable length of 0 to 10 bits, where a length of 0 bits indicates that the NRI is not used and therefore not applied in the core network nodes (e.g., MSC/VLR or SGSN) that serve a given pool area.

With the introduction of machine type communication (MTC) devices within PLMNs, the need to assign temporary identities is foreseen to help ensure device anonymity. Generally speaking these temporary identities may be domain independent or domain dependent—examples of the latter are the TMSIs assigned to those devices that operate in the circuit-switched domain and P-TMSIs assigned to those devices that operate in the packet-switched domain. The temporary identities assigned to these MTC devices may be associated with a specific core network node within the set of core network nodes that serve a given pool area. As a result, the use of the NRI concept may be necessary for supporting these devices.

Given that all MTC devices will be assigned either a TMSI or a P-TMSI (or have some other means for knowing the NRI associated with the serving core network node), the NRI concept may be used to manage MTC devices. In particular, the set of access control information described above can be expanded to include NRI information, thereby allowing for the selective barring of access attempts from MTC devices associated with one or more indicated NRIs. This can be particularly useful in the event that congestion problems are detected for one or several particular core network nodes, such as a particular SGSN in a GPRS network. In this case, access attempts can be throttled primarily for MTC devices assigned an NRI value corresponding to one of these problematic core network nodes.

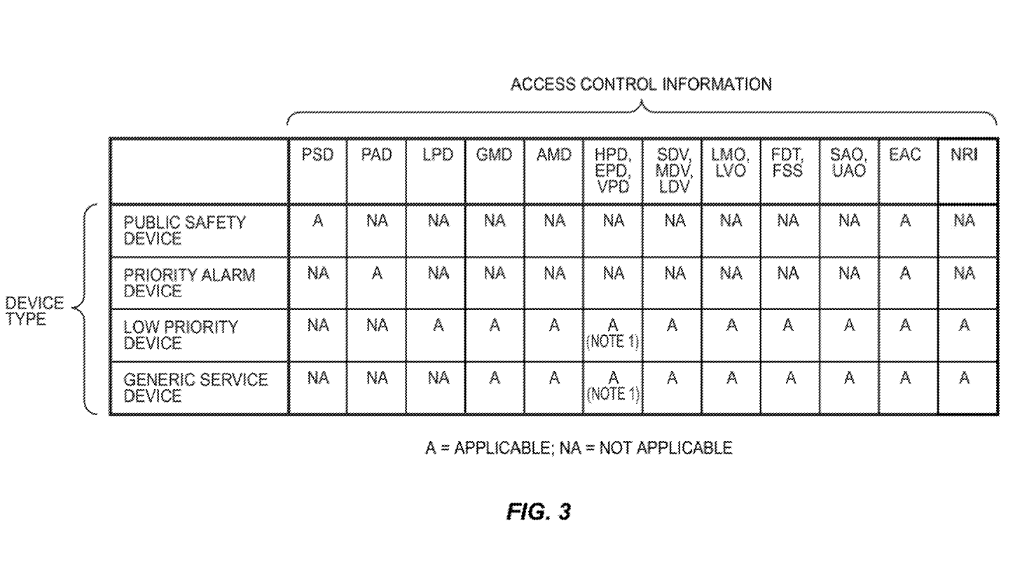

FIG. 3 illustrates a table similar to that of FIG. 2, but with the addition of a new column that includes NRI as part of the full set of access control information. This example table provides an example of how NRI can be applied on an MTC device-specific basis. Specifically, the table of FIG. 3 indicates that NRI-based access control is applicable to Low Priority Devices and Generic Service Devices, but not to Public Safety Devices or Priority Alarm Devices. Of course, other rules for applicability based on device type are possible.

It is also possible to make the applicability of NRI-based access control depend on the application type for which an access attempt is pending. For instance, an MTC could be configured with a pre-programmed rule that indicates that NRI-based access control is applicable for large data volume applications (LDV attribute), but not for small data volume applications (SDV attribute). Even further flexibility is possible if the MTC devices are configured to be updated with applicability rules that are transmitted over the air from time to time—these broadcast applicability rules may be used instead of or as a supplement to pre-programmed default rules.

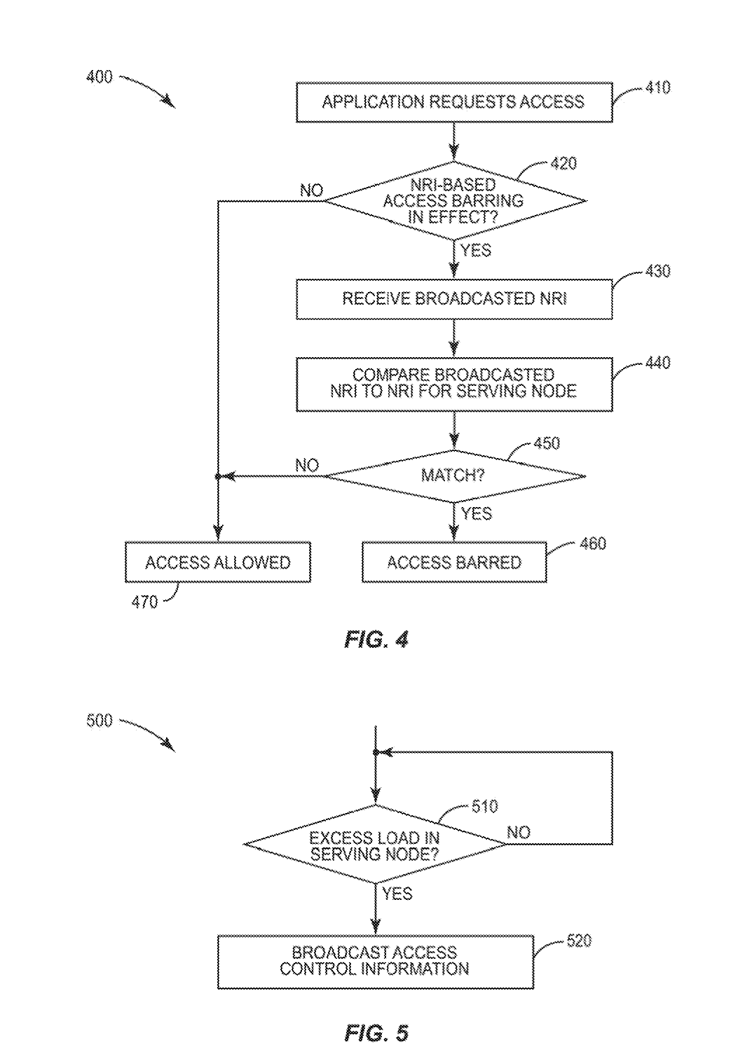

FIG. 4 illustrates an exemplary access control procedure 400 implemented by an access control function in an MTC device 100. The procedure begins, as shown at block 410, when an application requests access to send data. The application may be the sole application supported by an MTC device, in some instances, or may be one of several applications supported by the device. In either case, the application is associated with one or more service attributes, such as a device-specific service attribute or an application-specific service attribute.

As shown at block 420, when an application requests network access, the access control function in the MTC device 100 determines whether access barring based on NRI (or other network node identifier) is applicable to the application and/or device. In some embodiments, this determination is made by detecting a transmission of access control information broadcast from the mobile communication network, the access control information indicating that access barring based on serving node identifiers is in effect. In these and other embodiments, this determination may also include evaluating an access barring rule based on a device type for the access terminal or based on an application type corresponding to the impending access attempt, or based on both. In some cases, one or more access control information bits broadcast by the radio access network may indicate that NRI-based access barring is in effect for one or more device types and/or application types; the determination of whether NRI-based access is in effect for a given access attempt may take these access control information bits into account, in some embodiments.

If NRI-based access barring is not applicable to the impending access attempt, then access is allowed, as shown at block 470. Of course, the procedure illustrated in FIG. 4 assumes that only NRI-based access control is in effect. As discussed above, other access control layers may apply, in some embodiments.

If NRI-based access barring is applicable to the impending access attempt, on the other hand, then at least one transmitted NRI is received, as shown at block 430, and compared to the NRI of the serving node for the MTC device, as shown at block 440. If there is a match, as indicated at block 450, then access is barred, as shown at block 460. If not, then access is allowed.

Variations of the procedure illustrated in FIG. 4 are possible. For instance, the process flow diagram of FIG. 4 suggests that the broadcasted NRI is received only after the determination of whether NRI-based access barring is applicable. Instead, one or more NRIs may have already been received and stored by the MTC device for use in evaluating subsequent access attempts. In some systems, NRIs for nodes subject to access restrictions may be periodically broadcasted; monitoring MTC devices in these systems are configured to receive and store the NRIs for later use.

Those skilled in the art will also appreciate that NRI data for access control, as well as any other access control information discussed herein, may be transmitted in any of a number of formats. Access control information relating to application-specific service attributes, for instance, may be transmitted as access control words, where each bit corresponds to a particular service attribute or group of service attributes according to a pre-determined rule known to the MTC device and to an access control mechanism in the network. A given bit value (e.g., a “1”) indicates that access barring for the corresponding service attribute is in effect. In some embodiments, one of these bits may be used to indicate that access barring based on NRIs is in effect.

As noted above, NRIs may have a length ranging from 1 to 10 bits. A transmission format for sending one or more NRIs identifying nodes that are subject to access barring needs to account for this variable length. However, various formats are possible, including a variable-length format that includes a message header indicating the number of included NRIs or the length of the message, or both.

FIG. 5 illustrates an exemplary access control procedure 500 implemented by one or more fixed network nodes in a communication network, such as mobile communication network 12. The illustrated procedure 500 begins with the evaluation of loading in one or more serving nodes, as shown at block 510. If the load in a serving node exceeds a pre-determined threshold, then access control information is transmitted to one or more access terminals, as shown at block 520. The transmitted access control information indicates that access barring based on serving node identifiers (e.g., NRIs) is in effect. In some cases, the access control information identifies one or more affected serving nodes for use by the access terminals in determining whether their particular access attempts are barred.

The procedure illustrated in FIG. 5 may be implemented using several nodes in a communication system. For example, the evaluation of loading for any given serving node may take place at the serving node itself, in some embodiments. In these embodiments, the serving node may inform all of the base stations or radio network controllers in its pool area that its loading has exceeded a threshold. In response to this information, the base stations may then transmit (or be instructed to transmit) one or more NRIs within the access control information.

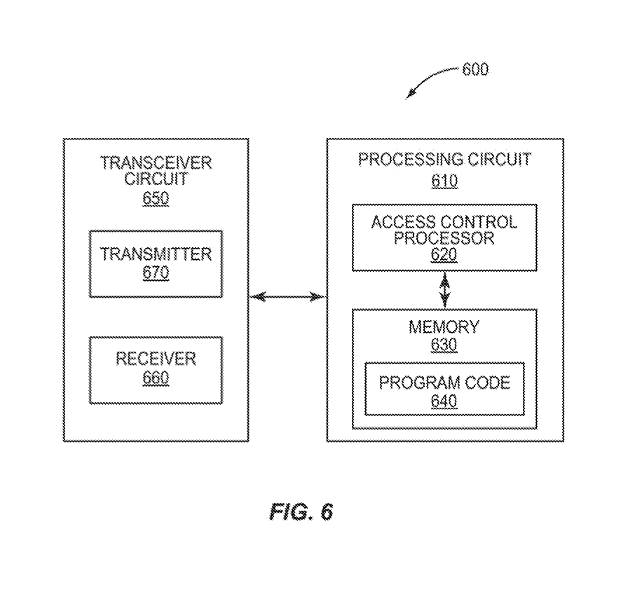

FIG. 6 illustrates an exemplary communication device 600 that may function as an MTC device, non-MTC device, or both. The communication device 600 includes a control unit 610 connected to a transceiver circuit 640 that communicates with base stations 20 in the mobile communication network 12. The processing circuit 610 includes an access control processor 620 and memory 630 for storing program code 632 controlling operation of the communication device 600. The program code 632 includes code for performing the access control functions as herein described. The transceiver circuit 640 comprises a receiver 660 and transmitter 650 for communicating with the base station 20. The transceiver circuit 640 may operate, for example, according to the GSM/EDGE standard or other communication standard.

Although not illustrated separately, it will be appreciated that the access control functions performed in one or more fixed network nodes may also be carried out using an access control unit having the same basic structure as control unit 610 in FIG. 6. In this case, program code corresponding to program code 632 is configured with instructions for carrying out the access control functionality of the network, such as according to the procedure illustrated in FIG. 5.

Of course, the present invention may be carried out in other specific ways than those herein set forth without departing from the scope and essential characteristics of the invention. One or more of the specific processes discussed above may be carried out in a cellular phone or other communications transceiver comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive, and all changes coming within the meaning and equivalency range of the appended claims are intended to be embraced therein.

What is claimed is:

1. An access control method implemented by an access terminal in a mobile communication network, wherein the access terminal is served by a serving core network node, said method comprising:
determining whether access barring based on serving node identifiers is applicable to the access terminal;
receiving a broadcasted serving node identifier;
comparing the broadcasted serving node identifier to an identifier for the serving core network node; and
selectively suppressing access activity by the access terminal based on said determining and said comparing.

2. The method of claim 1, wherein determining that access barring based on serving node identifiers is applicable to the access terminal comprises detecting a transmission of access control information broadcast from the mobile communication network, the access control information indicating that access barring based on serving node identifiers is in effect.

3. The method of claim 1, wherein determining that access barring based on serving node identifiers is applicable to the access terminal comprises evaluating a first access barring rule corresponding to an impending access attempt, based on a device type for the access terminal or based on an application type or based on both.

4. The method of claim 3, wherein the evaluating the first access barring rule is further based on broadcasted access control information received by the access terminal.

5. The method of claim 3, wherein the application type is one of a public safety application and a priority alarm application, and wherein said first access barring rule indicates that access barring based on serving node identifiers is not applicable for public safety applications and priority alarm applications.

6. The method of claim 3, wherein the application type is one of a low priority application and a generic service application, and wherein said access barring rule indicates that access barring based on serving node identifiers is applicable for low priority applications and generic service applications.

7. The method of claim 3, further comprising evaluating one or more additional access barring rules and corresponding broadcasted access control information to determine whether access activity by the access terminal should be suppressed, wherein said evaluating is based on the device type or the application type, or both.

8. The method of claim 7, wherein one or more of the additional access barring rules are based on device service attributes or application service attributes selected from the following:
group membership;
access point name;
home PLMN;
equivalent PLMN;
visited PLMN;
application data volume;
device mobility;
device visibility;
frequency of transmission;
frequency of server signaling;
solicited operation; and
extended access class membership.

9. The method of claim 1, wherein the serving core network node is a Serving GPRS Support Node in a GPRS network and the serving node identifiers consists of Network Resource Identifiers (NRIs).

10. An access terminal for use in a mobile communication network wherein the access terminal is served by a serving core network node, the access terminal comprising a radio transceiver and a processing circuit configured to:
determine whether access barring based on serving node identifiers is applicable to the access terminal;
receiving a broadcasted serving node identifier, via the radio transceiver;
compare the broadcasted serving node identifier to an identifier for the serving core network node; and
selectively suppress access activity by the access terminal based on said determining and said comparing.

11. The access terminal of claim 10, wherein the processing circuit is configured to determine that access barring based on serving node identifiers is applicable to the access terminal by detecting a transmission of access control information broadcast from the mobile communication network, the access control information indicating that access barring based on serving node identifiers is in effect.

12. The access terminal of claim 10, wherein the processing circuit is configured to determine that access barring based on serving node identifiers is applicable to the access terminal by evaluating a first access barring rule corresponding to an impending access attempt, based on a device type for the access terminal or based on an application type or based on both.

13. The access terminal of claim 12, wherein the evaluating the first access barring rule is further based on broadcasted access control information received by the access terminal.

14. The access terminal of claim 12, wherein the application type is one of a public safety application and a priority alarm application, and wherein said first access barring rule indicates that access barring based on serving node identifiers is not applicable for public safety applications and priority alarm applications.

15. The access terminal of claim 12, wherein the application type is one of a low priority application and a generic service application, and wherein said access barring rule indicates that access barring based on serving node identifiers is applicable for low priority applications and generic service applications.

16. The access terminal of claim 12, wherein the processing circuit is further configured to evaluate one or more additional access barring rules and corresponding broadcasted access control information to determine whether access activity by the access terminal should be suppressed, wherein said evaluation is based on the device type or the application type, or both.

17. The access terminal of claim 16, wherein one or more of the additional access barring rules are based on device service attributes or application service attributes selected from the following:
group membership;
access point name;
home PLMN;
equivalent PLMN;
visited PLMN;
application data volume;
device mobility;
device visibility;
frequency of transmission;
frequency of server signaling;
solicited operation; and
extended access class membership.

18. The access terminal of claim 10, wherein the serving core network node is a Serving GPRS Support Node in a GPRS network and the serving node identifiers consists of Network Resource Identifiers (NRIs).

19. An access control method implemented by one or more fixed network nodes in a mobile communication network that includes a serving core network node serving one or more access terminals, the method comprising:
determining that a processing load associated with at least a first category of access terminals exceeds a pre-determined threshold; and
responsive to said determining, broadcasting access control information to a plurality of access terminals, the access control information indicating that access barring based on serving node identifiers is in effect.

20. The method of claim 19, wherein the access control information identifies one or more affected serving nodes.

21. An access control apparatus in a mobile communication network that includes a serving core network node serving one or more access terminals, the access control apparatus comprising one or more processing circuits configured to:
determine that a processing load associated with at least a first category of access terminals exceeds a pre-determined threshold; and
in response to said determining, broadcast access control information to a plurality of access terminals, via one or more radio access nodes, the access control information indicating that access barring based on serving node identifiers is in effect.

22. The apparatus of claim 21, wherein the access control information identifies one or more affected serving nodes.
